(19) United States
(12) Patent Application Publication
(10) Pub. No.: US 2018/0225724 A1
(43) Pub. Date: Aug. 9, 2018

(54) Sponsored Event Management Platform

(71) Applicant: Vity Patent Holdco, LLC, Loveland, CO (US)

(72) Inventor: Lynne Haaland, Burbank, CA (US)

(21) Appl. No.: 15/428,361

(22) Filed: Feb. 9, 2017

(51) Int. Cl. G06Q 30/02; G06Q 50/00

(52) U.S. Cl. CPC G06Q 30/0277; G06Q 30/0275; G06Q 30/0269; G06Q 30/0244; G06Q 50/01

(57) ABSTRACT

A platform for managing sponsored events, where an event may have one or more sponsorship packages. The sponsorship packages may include various advertising mechanisms, including social media influencer advertising. The platform may permit advertisers to browse, select, modify, negotiate, and bid on a sponsorship package, as well as permit social media influencer to browse, select, modify, negotiate, and bid on social media influencer activities associated with a sponsored package. The sponsorship package may be dynamically updated as items may be added, removed, or purchased by advertisers and social media influencers.

### BACKGROUND

Events are one vehicle for advertisers and marketers to reach an audience. Sponsors of an event typically have their brand associated with an event in several different ways.

An event may be a conference, athletic contest, meeting, or any other gathering of people. In some cases, the event may be a physical event where people physically gather, such as in a hall, stadium, theater, or other venue. Another type of event may be a televised or virtual event where people may watch, attend, or participate through television or a computer. Some such events may include participation through social media, webinars, or any other type of communication platform.

Sponsoring an event is one way that brands can bring awareness. Many events list their sponsors and provide banners, booths, or any of a host of different ways that the brand can be brought to the attention of the attendees.

### SUMMARY

A platform for managing sponsored events, where an event may have one or more sponsorship packages. The sponsorship packages may include various advertising mechanisms, including social media influencer advertising. The platform may permit advertisers to browse, select, modify, negotiate, and bid on a sponsorship package, as well as permit social media influencer to browse, select, modify, negotiate, and bid on social media influencer activities associated with a sponsored package. The sponsorship package may be dynamically updated as items may be added, removed, or purchased by advertisers and social media influencers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a dynamic event management platform.

FIG. 2 is a diagram illustration of an embodiment showing a schematic or functional representation of a network with an event management platform.

FIG. 3 is a flowchart illustration of an embodiment showing a method for interacting between an event manager and an advertiser through an event management platform.

FIG. 4 is a flowchart illustration of an embodiment showing a method for interacting between an event manager and an advertiser to sell a sponsorship package.

FIG. 5 is a diagram illustration of an embodiment showing a user interface for submitting a bid on a sponsorship package.

FIG. 6 is a flowchart illustration of an embodiment showing a method for interacting between two advertisers who may compete through an auction process for a sponsorship package.

### DETAILED DESCRIPTION

Sponsored Event Management Platform

A sponsored event management platform may include online tools for managing an event and particularly the advertising aspects of an event. A sponsored event may typically start with an event organizer who may arrange a venue, participants, and other aspects of the event. One aspect may be a set of advertising sponsorship opportunities for the event.

In many cases, advertising opportunities may be a package of several advertising items. Many sponsored events may offer a tiered sponsorship, where there may be gold, silver, and bronze level sponsorships for example. Each increasing level or tier may have more prominent placement, additional features, different opportunities, and the like. An event organizer may arrange the sponsorship packages to attract certain advertisers who may wish to reach the event's audience.

A sponsored event management platform may include an event manager interface through which an event manager may create an event, describe the event, and create sponsorship packages. The event and the various sponsorship packages may be made available to advertisers through an online platform. The advertisers may be able to select, modify, negotiate, bid, and otherwise interact with the sponsorship programs.

Dynamic Sponsorship Packages

An online platform may manage sponsorship packages for events. An event may have one or more pages that may describe the event for an advertiser. A typical event description may include general information about the event, along with anticipated demographics of the audience, audience reach, and other data.

The description of the event and sponsorship packages may change as advertisers and other participants interact with the online event data. For example, a sponsorship package may be updated to add a feature that an advertiser may request. An advertiser may initiate negotiations with a specific package, and that status change may be reflected to the online description. When a package may be agreed upon, the status of the package may be updated, reflecting that the package may be unavailable for purchase. In some cases, the brands that have purchased sponsorship may be displayed for other advertisers to see.

The event description may be available on a web page or other online format. Once created and launched, various aspects of the online description may be updated in real time. For many events that may be produced rapidly, the dynamic updates may help everyone involved have the most up to date information.

In many cases, an event description may not be available to the general public, but may be made available after entering credentials or otherwise authenticating. Some systems may include descriptions of many events, and certain parameters of the events may be searchable across multiple events.

For example, an advertiser may search the dynamic sponsorship packages to find those packages that may reach their target demographic and may be within the cost constraints of their budget.

Advertisers are often very interested in the specific demographic profile of the participants in an event. For repeated events, such as an annual conference, the demographics from the previous year's event may be used. For newly curated events or for events that may have new features or components, the demographics may be much more uncertain.

The demographics of an event may be updated based on confirmed attendees or participants of an event. The demographic profile may be derived from social media profiles of the attendees or participants, and specifically from the demographic profiles of a person's followers.

An advertiser's scope of influence of an event may not merely reflect the precise demographic profile of the actual attendees, but the demographic profiles of the social media reach of the attendees. Such a profile may reflect the actual marketing power of a specific event in that the advertising reach of the attendee's social media followers may be much larger than just the attendees.

Event Management and Sponsorship Offerings

An online event management system may provide multiple sponsorship packages to advertisers. Each sponsorship package may be a set of advertising or messaging options that may be available. For example, a sponsorship package may include branding in conspicuous spaces, a speaking opportunity to address attendees, opportunity to give away apparel, naming rights to all or a portion of the event, or any of countless options.

The sponsorship packages may be curated for events to reflect the tone of the event. A high technology conference may have a much different tone and have different advertising opportunities than, say, a religious conference or an athletic event. However, many event organizers may allow advertisers to pick and choose which advertising options they want, and may allow some advertisers to add new advertising options. Typically, such a negotiation may include negotiation on price.

Further, an event organizer may be trying to attract as many advertisers as possible to an event. During the process of organizing an event, sponsorship opportunities may become a scarce commodity, as advertisers snatch up the sponsorship opportunities, leaving fewer packages for late-deciders.

The event management platform may dynamically indicate changes in the sponsorship opportunities to interested advertisers. Such changes may include whether a sponsorship package may be purchased, changed, under negotiation, or other status. In many cases, a particular sponsorship package may have an indicator to show how many advertisers have viewed the package, how many have inquired about the package, or have some other indicator of interest by other advertisers.

Some systems may have an auction or other negotiation process for bidding on a sponsorship package. Such systems may allow multiple advertisers to compete to determine the pricing and contents of a sponsorship package. Various auction-style negotiation or bidding systems may be used. In some cases, the auctions may be offered for just price, although other systems may allow auctions or negotiations on the contents of the sponsorship package, such as adding, removing, or changing specific elements of the package.

Some systems may have a competitive database that may contain an advertiser's competitors. Many advertisers may not wish to participate in an event when their competitor may also be advertising, or the advertiser may wish to purchase a larger sponsorship package than their competitors.

An online event management system may recognize an advertiser's competitors and may make certain information available or unavailable based on activities of the other advertisers. For example, a first soft drink manufacturer may have a policy of being the sole soft drink provider for an event. If another soft drink manufacturer were bidding on a sponsorship package, the first manufacturer may be alerted and advised to bid on a sponsorship of the event.

Some systems may permit a sponsor to dictate that a group of other advertisers may not participate in the event. In the example of a soft drink manufacturer, a sponsorship package may include a provision that their sponsorship may be contingent on a group of other advertisers not participating in the event. Such provisions may hide or lock out certain events or portions of events from advertisers that may not be permitted to participate in an event.

The online and dynamically updated event management system may give advertisers a real-time view of negotiations that may be ongoing for an event. Such real-time data may cause advertisers to make faster decisions about their sponsorship packages or to negotiate or bid on packages.

Social Media Influencer Marketing Packages

A marketing package may be created for social media influencers. Such packages may be offered as a component of an event sponsorship. Some systems may have a two-sided marketplace, where an event curator may create a sponsorship package that may include a social media influencer component, then may offer the social media influencer component to social media influencers who may then bid or negotiate to provide social media influencer services.

In some events, social media influencers may create packages that may be purchased by advertisers in conjunction with an event. Such packages may be an add-on component that an advertiser may purchase to highlight or augment the advertiser's investment in their sponsorship.

Such social media packages may be offers for social media influencers to promote various aspects of an event. In some cases, the offers may be to combine the event promotion as well as an advertiser's product.

Social media influencers may have preexisting sponsorship agreements with certain advertisers. In some cases, such agreements may prohibit an influencer from advertising for or being associated with a group of prohibited advertisers. When such agreements exist, social media packages for prohibited advertisers or social media influencers may be excluded from being offered to parties that would violate the agreements.

For the purposes of this specification and claims, an event may be any gathering where advertisers may wish to have a presence. For example, an event may be a business conference or meeting, an athletic contest, a non-profit fundraising event, a party, or some other gathering. In many cases, an event may be a virtual event or gathering, such as a television program, an online webinar, or some other vehicle where advertisers may be exposed to their target audience. Some events may be one-time events, while other events may be recurring.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory. When the subject matter is embodied in “non-transitory” media, the media may be any storage media that expressly does not include live signals.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

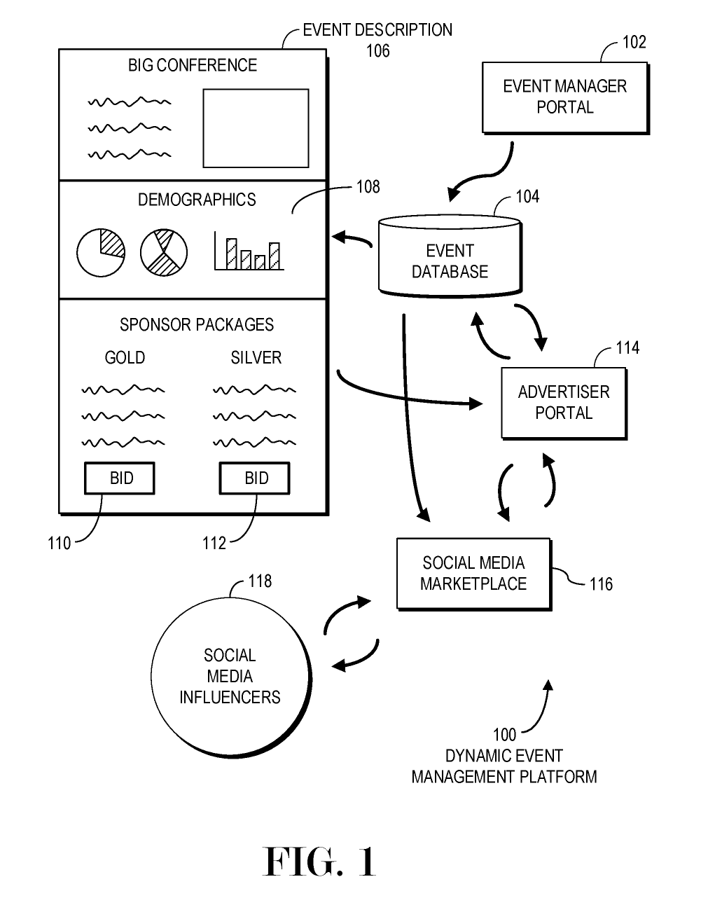

FIG. 1 is a diagram illustration of a dynamic event management platform. An event manager portal 102 may be a mechanism through which an event manager may create an event description, sponsorship packages, and other items, which may be stored in an event database 104.

An event description 106 may include an advertisement for an event, along with demographics 108 and sponsor packages 110 and 112.

An event may be any opportunity to advertise a product, service, or company. A sponsorship package may include a suite of items for advertisement, such as product placement, logo placement, speaking opportunities, placing items in gift bags, sponsoring portions of an event, a booth for promoting a company, or any other mechanism to advertise a product at an event.

The event description 106 may be given to advertisers to solicit bids for sponsorship packages. The event description 106 is an advertisement for advertising at an event.

The demographics 108 may include the attendees and other people that the event may be targeting. For example, some events may include demographics of the attendees, and some may include demographics of the people influenced or touched by the event. When social media influence may be considered, an event may reach not only the attendees, but the social media followers of the attendees.

In some cases, the demographics 108 may be updated dynamically for the event description 106. A dynamic update may be performed as attendees may be confirmed for the event. One method for determining the demographics 108 may be to analyze the social media presence of attendees to aggregate and summarize the social media influence of the attendees. As each attendee may be confirmed, the demographics 108 may be updated.

The sponsorship packages in the example may include gold and silver packages 110 and 112. A sponsorship package may include a group of items that an advertiser may wish to use to promote their brand, product, service, or perform other outreach. In many cases, a sponsorship package may be negotiable, especially for the higher end packages. Many event sponsors may put together several sponsorship packages as a starting point for a negotiation, then may accept additions or deletions to the sponsorship packages. In many cases, an event sponsor may accept payment for less than a suggested price.

In some cases, two or more advertisers may bid on a sponsorship package. In such cases, online tools may assist the participants in submitting their bids and negotiating to a final price. The participants may include just the competing advertisers, but may also include the event manager in some cases.

A bidding system may allow advertisers to submit proposed changes and pricing for sponsorship packages. A computer user interface may allow an advertiser to add, remove, or modify items in a sponsorship package, as well as offer different amounts of money for a sponsorship package. In some systems, a back and forth negotiation may occur between an advertiser and an event manager, while in some systems, such negotiation may be fully or partially automated.

The event description 106 may be a dynamic, computer generated description that may be displayed to various advertisers. The dynamic nature of the display may allow a system to update portions of the event description 102 in real time or near real time. For example, the status of a sponsorship package may be updated from “available” to “negotiating” when an advertiser may submit a bid or show interest in the package. Once the sponsorship package contract may be signed and payment made, the status may be changed to “purchased” or “unavailable.” The statuses given in this example are merely one way that the statuses may be described and the conditions under which the statuses may be made.

The dynamic nature of the event description 106 may allow different versions of an event description 106 to be created and displayed for different advertisers. For example, an advertiser who may be promoting a certain type of product or service may be presented with one view or event description 106 that may be different from another advertiser who may be promoting a different type of product or service.

In many cases, an advertiser may have certain competitors, brands, or products with which the advertiser may not wish to be associated. Some events may have sponsorship packages that may allow only one advertiser in a specific category, or may allow one advertiser to exclude another advertiser or group of advertisers from the event. Such exclusivity agreements may be enforced by displaying only the applicable events or sponsorship packages that may be available to an advertiser in view of various exclusivity agreements or contracts.

Some systems may alert an advertiser's competitors when a competitor may be bidding on a sponsorship package. Such systems may attempt to get two competitors to bid against each other for a sponsorship package through an auction system or through a first-come-first-served process.

An advertiser may access the event database 104 through an advertiser portal 114. The advertiser portal 114 may be any type of computer system, such as a web server, through which an advertiser may access the event database 104. In a typical use, an advertiser may register and create an account. In some cases, the account may be manually verified to determine that the advertiser may be an actual advertiser. In other systems, anyone may establish an account and access the advertiser portal.

Some systems may have a social media influencer marketplace 116. The social media influencer marketplace 116 may allow advertisers or event managers to submit projects for social media influencers 118. Each of the projects may be a request for a social media influencer to promote the event or some aspect of an event. In some cases, a social media influencer project may be a part of a sponsorship package. In some cases, a social media influencer project may be a supplemental project to a sponsorship package. For example, once a sponsorship package may be purchased by an advertiser, a social media influencer project may be started to recruit social media influencers to promote the advertiser's involvement in the event.

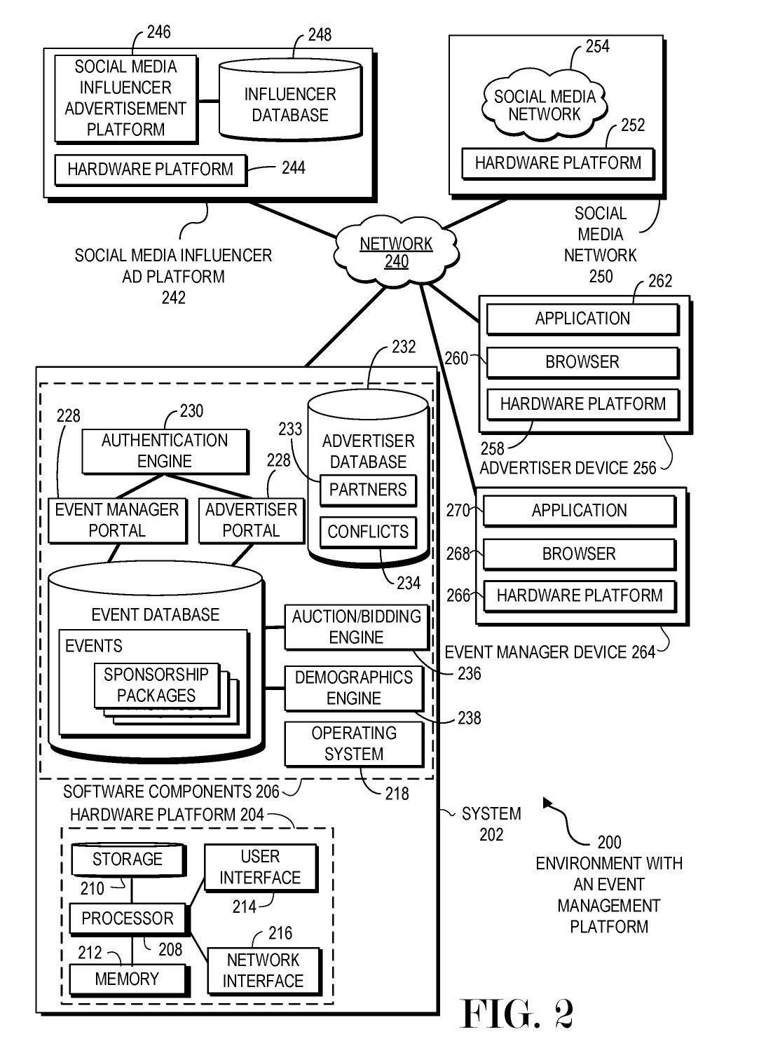

FIG. 2 is a diagram of an embodiment 200 showing components that may manage influencer marketing campaigns. The components are illustrated as being connected across a network 240.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a system 202 that may have a hardware platform 204 and various software components. The system 202 as illustrated represents a conventional computing device, although other embodiments may have different configurations, architectures, or components.

In many embodiments, the system 202 may be a server computer. In some embodiments, the system 202 may still also be a desktop computer, laptop computer, netbook computer, tablet or slate computer, wireless handset, cellular telephone, game console or any other type of computing device. In some embodiments, the system 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

An event database 220 may contain descriptions of various events 222. Each of the events 222 may contain one or more sponsorship packages 224. The events may be advertising venues, such as conferences, athletic events, and other get togethers. In some cases, events may include television programming, online video events, motion picture projects, and other media projects where sponsorship, product placement, and other advertising actions may be used.

A sponsorship package 224 may be a group of advertising components or devices that may be purchased by an advertiser. In many cases, an event manager may curate several sponsorship packages and attempt to have advertisers purchase or bid on the packages. Advertisers may view the sponsorship packages and event description to determine whether or not the event may be appropriate for their advertising.

An event manager portal 226 may be a website, application programming interface, application, or other mechanism by which an event manager may access the system 202. The event manager may have the ability to create an event, add descriptions, graphics, or other media describing the event, as well as define sponsorship packages for advertisers. In many cases, an event manager may define certain portions of a sponsorship package as fixed and others as variable. The variable components may be portions that may be added, removed, or modified to suit an advertiser's wishes.

An advertiser portal 228 may be a website, application programming interface, application, or other mechanism by which an advertiser may access the system 202. The advertiser may be able to view events and sponsorship packages, as well as submit purchase requests or bids for packages. In some cases, an advertiser may negotiate with an event manager or another advertiser to purchase a sponsorship package.

An authentication engine 230 may be a system that may authenticate event managers, advertisers, and other users of the system 202. The authentication engine 230 may use any type of credential or authentication mechanism to permit or deny access to the system 202.

An advertiser database 232 may have entries for each advertiser. In a typical use case, an advertiser may create an account and store various information in the advertiser database 232. In many cases, an advertiser may identify partners 233 and conflicts 234.

A partner 233 may be any other business, brand, influencer, person, or organization with which an advertiser may have a casual affinity or, in some cases, a mutual contractual relationship. A conflict 234 may be a competitor company, brand, person, influencer, or other organization that may conflict with an advertiser.

A partner 233 or conflict 234 may be defined by listing specific companies, persons, organizations, or groups. In some cases, a partner 233 or conflict 234 may be defined by categories or types. For example, a company in the soft drink business may merely list a category of soft drinks as a conflict, rather than enumerating each company that may produce soft drinks.

A partner 233 or conflict 234 may be used to customize the view an advertiser may see for a particular event. For example, when a competitor has purchased a sponsorship package that may include a category exclusivity clause, an advertiser may not be permitted to bid or purchase a sponsorship package for an event per the exclusivity clause. In another example, during the negotiation phase with one advertiser, a competitor may see that negotiation may be taking place with a competitor, which may alert the advertiser that they may submit a bid and begin negotiations quickly or they may be left out.

An auction or bidding engine 236 may handle the back and forth of bidding or negotiation for different sponsorship packages. In some cases, the auction or bidding engine 236 may allow one advertiser to bid against another advertiser for the same sponsorship packages. In some cases, the auction or bidding engine 236 may allow an advertiser to negotiate with an event organizer for a sponsorship package.

A demographics engine 238 may generate demographic information about the attendees or other people who may be affected by the event. In some cases, a demographics engine 238 may analyze people who may be associated with the event to determine their demographic profile and, in some cases, the demographic profile of their social media followers or advertising reach. The demographics engine 238 may, in some cases, update the demographic profile of an event dynamically.

A network 240 may be any type of communications network by which the system 202 may communicate with other devices or systems.

A social media influencer advertisement platform 242 may have a hardware platform 244 on which a social media influencer advertisement system 246 may operate. An influencer database 248 may be used to store influencer information.

A social media influencer advertisement platform 246 may act as a marketplace where influencers and advertisers may engage each other. In general, an advertiser may pay an influencer to promote the advertiser's brand, product, or service. In many cases, social media influencers may be hired by advertisers for individual posts or other small contracts, but in some cases, advertisers may hire influencers for long term contracts which may span days, weeks, months, or longer.

Many social media influencer advertisement platforms may allow influencers to post offers for advertisers, review advertiser's requests, and negotiate a contract. The social media influencers may have a following on various social media platforms, and those followings may be analyzed by the demographics engine 238 to determine an influencer's audience reach for activities that may be associated with an event.

A social media network 250 may have a hardware platform 252 on which a social media network 254 may operate. Social media networks may be any type of person to person or other network of people, where individuals may share information that may be consumed by other people in the network. Some networks may have a double opt-in connection, where both people on a connection may assent to a connection. Other networks may have a one-way opt-in, where one person may “follow” or connect with another, without the second person's consent.

Online social networks may represent explicit or implicit connections between individual people. These connections may be powerful advertising conduits where some degree of trust may be present between people. An influencer may be any person who may use that sense of trust to advertise to another person. Such advertisements may be very effective in some circumstances.

An advertiser device 256 may be any device by which an advertiser may connect with the system 202. A typical device may have a hardware platform 258 on which a browser 260 or application 262 may execute. The browser 260 or application 262 may connect to a website, application programming interface, or some other connection on the advertiser portal 228 to access the various functions of an advertiser.

An event manager device 264 may be any device by which an event manager may connect with the system 202. A typical device may have a hardware platform 266 on which a browser 268 or application 270 may execute. The browser 268 or application 270 may connect to a website, application programming interface, or some other connection on the event manager portal 226 to access the various functions of an event manager.

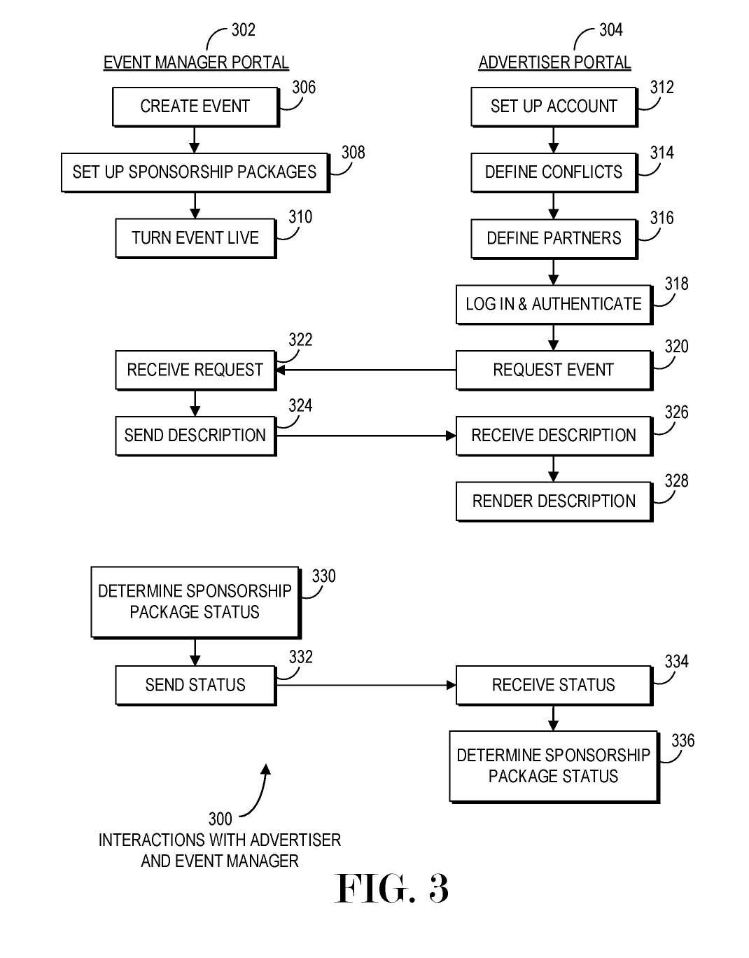

FIG. 3 is a flowchart illustration of an embodiment 300 showing a method performed when an event may be created and viewed. The operations of an event manager portal 302 may be shown in the left hand column, while the operations of an advertiser portal 304 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may be a simplified method by which an event manager may use an event manager portal 302 may create an event, then have an advertiser interact with the event through an advertiser portal 304.

An event may be created in block 306, as well as some sponsorship packages in block 308. Through this process, an event manager may add text descriptions, graphics, video, audio, and various media elements to the description. In some cases, the event description may be a web page or series of web pages that may be rendered each time the event may be accessed. In many cases, the event rendering may change from one instance to the next, and some of the description may be customized or changed with each viewing.

After creating an event and sponsorship packages, the event may be turned live in block 310.

Through the advertiser portal 304, an advertiser may setup an account in block 312, and may define conflicts in block 314 and partners in block 316. The conflicts may be other advertisers who may conflict with the advertiser and who may be excluded from the event under an exclusivity clause. The partners may be other advertisers who may have a friendly relationship with the advertiser and who may also wish to advertise alongside the advertiser.

The advertiser may log in and authenticate in block 318 and may request the event in block 320. The event manager may receive the request in block 322 and may send a description of the event in block 324. The event description may be received in block 326 and may be rendered in block 328.

The event manager may determine a sponsorship status in block 330 and may transmit the status in block 332. The advertiser portal 304 may receive the status 334 for the sponsorship package and may display the status in block 336.

The status may be different for various systems. In some systems, a status may be “available”, “negotiating”, “unavailable”, or “sold”. Other systems may have different labels for the status.

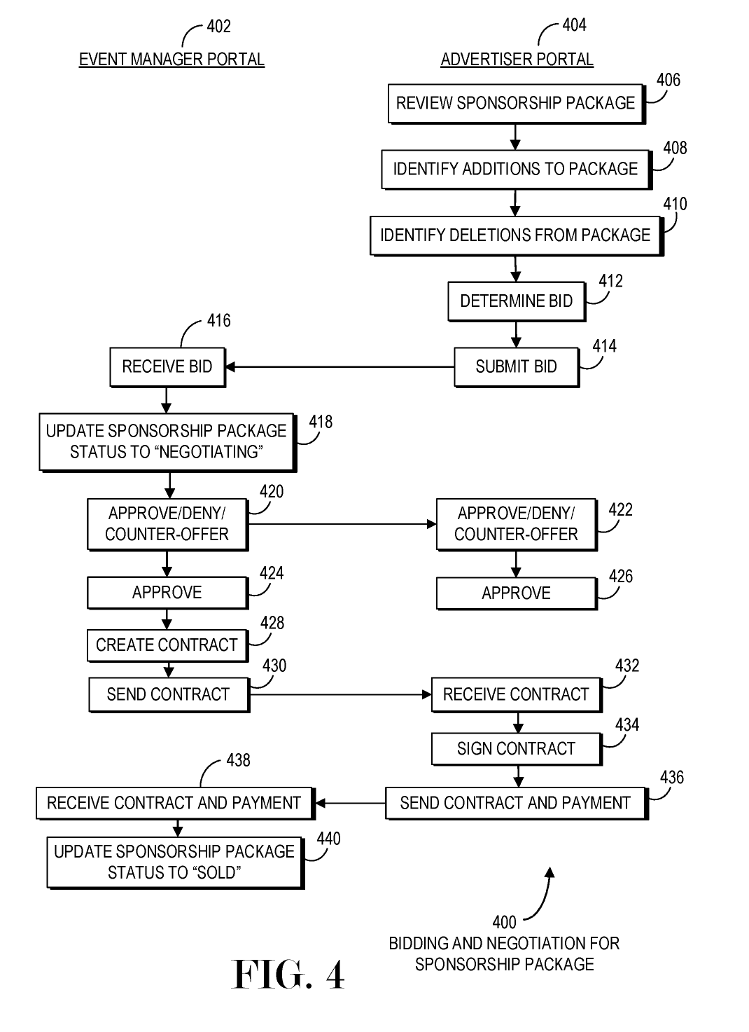

FIG. 4 is a flowchart illustration of an embodiment 400 showing a method performed when an advertiser may submit a bid for a sponsorship package. The operations of an event manager portal 402 may be shown in the left hand column, while the operations of an advertiser portal 404 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is merely one simplified example of the operations that may be performed when an advertiser makes an offer for a sponsorship package. Some embodiments may allow the advertiser to suggest changes to the sponsorship package and submit a price bid. These may be negotiated until approved by both the advertiser and the event organizer.

An advertiser may review a sponsorship package in block 406, then may specific additions to the package in block 408 and deletions to the package in block 410. The advertiser may determine bid in block 412, which may be submitted in block 414.

The bid may be received by an event organizer in block 416. In many cases, a system may send a message or alert to an event organizer that a new bid may have arrived. Because a bid has been received, the sponsorship package status may be updated to “negotiating”. Such a status may indicate to other advertisers that the package is being considered by someone else, and such a status may prompt another advertiser to submit a bid as well.

In blocks 420 and 422, both the event organizer and advertiser may approve, deny, or counter offer each other. Such a negotiation may be done through a user interface that may allow an advertiser or event organizer to update or change various descriptors relating to the sponsorship package. An example of such an interface may be found in embodiment 500.

Once the sponsorship offer has been approved by both parties in blocks 424 and 426, the event manager may create a contract in block 428 and transmit the contract in block 430. The advertiser may receive the contract in block 432, sign the contract in block 434, and may transmit the contract and sponsorship payment in block 436. The event manager may receive the contract and payment in block 438, and may update the sponsorship package status to “sold” in block 440.

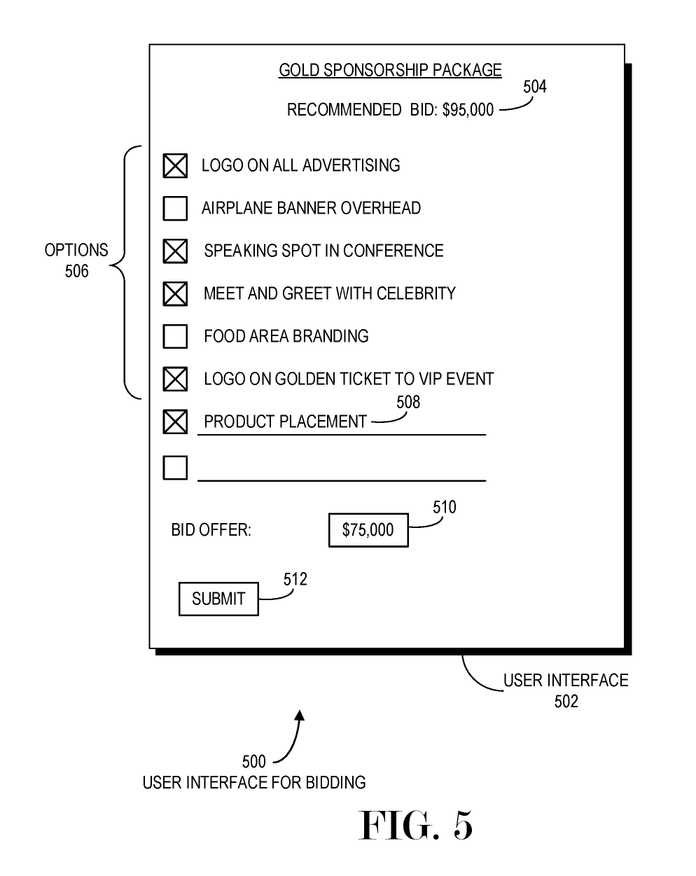

FIG. 5 may be an example illustration of an embodiment 500 showing a user interface 502 for bidding on a sponsorship package. This example is merely one mechanism by which an advertiser or even manager may update a sponsorship package, then submit the package to the other party as a bid.

The illustration of a “Gold Sponsorship Package” is shown with a recommended price of $95,000 at item 504.

The various options 506 are illustrated as having individual check boxes by which an advertiser may indicate which sponsorship components the advertiser may wish to include or exclude from the package. The item 508 may be an open line through which an advertiser may add a new sponsorship component to the package. An offer 510 may be the price that the advertiser may wish to submit.

When an advertiser completes the user interface, the advertiser may hit the submit button 512 to transmit the bit to the other party.

The example of embodiment 500 may also be used to counter offer an advertiser. In such a use, an event manager may see the interface 502, and may make changes to the package, such as adding or removing components or changing the price. Such a use may have the bids go back and forth between parties until an agreement may be made.

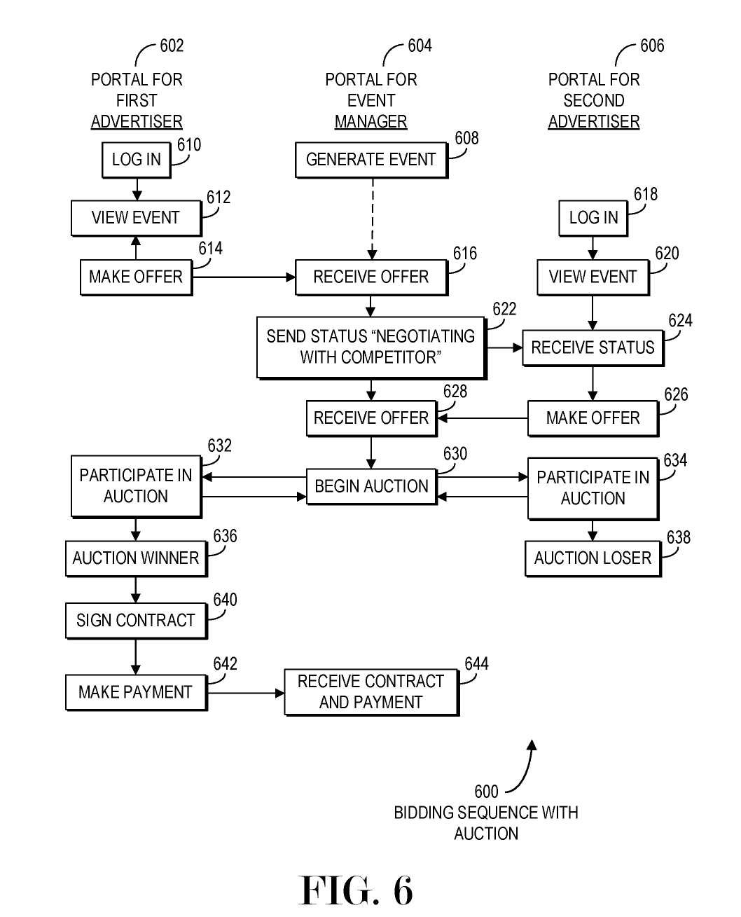

FIG. 6 is a flowchart illustration of an embodiment 600 showing a method performed when two advertisers may compete for a sponsorship package. The operations of a portal for a first advertiser 602 may be shown in the left hand column, a portal for an event manager 604 may be shown in the center column, and the operations of a portal for a second advertiser 606 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 may illustrate a process that may occur when two advertisers may wish to bid on the same sponsorship package. Advertiser portals may provide a user experience through which advertisers may indicate their interest for a sponsorship package, then may begin an auction sequence to determine a price and feature set.

Some systems may allow the advertisers to bid on price alone, while other systems may allow advertisers to add or remove different components of a sponsorship package as well as adjust price during the auction or negotiation.

An event may be generated through the event manager portal in block 608.

A first advertiser may log in in block 610 and view the event in block 612. The first advertiser may make an offer in block 614, which may be received in block 616.

A second advertiser may log in in block 618 and view the event in block 620. Since the first advertiser had already made an offer, the event manager may send a status for the sponsorship package of “negotiating with competitor” in block 622, which may be received in block 624.

In response, a second advertiser may make an offer in block 626, which may be received in block 628. An auction may be initiated in block 630 and the advertisers may participate in blocks 632 and 634. Some auctions may be very quick, while other auctions may be slow. At the end of the auction, the first advertiser may be a winner in block 636, while the second advertiser may be a loser in block 638.

The first advertiser may sign a contract in block 640 and make the payment in block 642, which may be received in block 644.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a hardware platform comprising at least one computer processor;
a sponsored event management platform operating on said hardware platform, said sponsored event management platform configured to:
receive an event description, said event description comprising a description of a first sponsorship package;
receive a first request from a first advertiser for said event description;
receive a first conflicts list for said first advertiser, said first conflicts list defining a second advertiser;
display said event description to said first advertiser;
determine a current status for said first sponsorship package and displaying said description of said first sponsorship status along with an indicator for said current status;
receive a first proposal from said first advertiser, said first proposal comprising an offer for said first sponsorship package; and
update said current status for said first sponsorship package to a negotiation status.

2. The system of claim 1, said sponsored event management platform further configured to:
receive a second request from said second advertiser for said event description; and
determine that said second advertiser is defined in said first conflicts list.

3. The system of claim 2, said sponsored event management platform further configured to:
determine that said first advertiser has purchased said first sponsorship package; and
display an indicator to said second advertiser indicating said first sponsorship package is not available.

4. The system of claim 2, said sponsored event management platform further configured to:
determine that said first advertiser has not purchased said first sponsorship package; and
display an indicator to said second advertiser indicating said first sponsorship package is being negotiated by a competitor.

5. The system of claim 1, said sponsored event management platform further configured to:
receive a change request for said first sponsorship package;
determine that said change request is approved; and
update said first sponsorship package with said change request.

6. The system of claim 5, said sponsored event management platform further configured to:
transmit said change request to an event coordinator; and
receive an approval from said event coordinator for said change request.

7. The system of claim 6, said sponsored event management platform further configured to:
display a plurality of advertising opportunities as part of said first sponsorship package, said plurality of advertising opportunities comprising a first advertising opportunity; and
receive a selection of a first advertising opportunity to be removed from said first sponsorship package as part of said first proposal from said first advertiser.

8. The system of claim 7, said sponsored event management platform further configured to:
receive a first price bid for said first sponsorship package from said first advertiser.

9. The system of claim 8, said sponsored event management platform further configured to:
transmit said first price bid to said event coordinator.

10. The system of claim 9, said sponsored event management platform further configure to:
receive approval from said event coordinator for said first price bid; and
transmit a contract to said first advertiser for said first sponsorship package.

11. A method performed on at least one computer processor, said method comprising:
receiving an event description, said event description comprising a description of a first sponsorship package;
receiving a first request from a first advertiser for said event description;
receiving a first conflicts list for said first advertiser, said first conflicts list defining a second advertiser;
displaying said event description to said first advertiser;
determining a current status for said first sponsorship package and displaying said description of said first sponsorship status along with an indicator for said current status;
receiving a first proposal from said first advertiser, said first proposal comprising an offer for said first sponsorship package; and
updating said current status for said first sponsorship package to a negotiation status.

12. The method of claim 11 further comprising:
receiving a second request from said second advertiser for said event description; and
determining that said second advertiser is defined in said first conflicts list.

13. The method of claim 12 further comprising:
determining that said first advertiser has purchased said first sponsorship package; and
displaying an indicator to said second advertiser indicating said first sponsorship package is not available.

14. The method of claim 12 further comprising:
determining that said first advertiser has not purchased said first sponsorship package; and
displaying an indicator to said second advertiser indicating said first sponsorship package is being negotiated by a competitor.

15. The method of claim 11 further comprising:
receiving a change request for said first sponsorship package;
determining that said change request is approved; and
updating said first sponsorship package with said change request.

16. The method of claim 15 further comprising:
transmitting said change request to an event coordinator; and
receiving an approval from said event coordinator for said change request.

17. The method of claim 16 further comprising:
displaying a plurality of advertising opportunities as part of said first sponsorship package, said plurality of advertising opportunities comprising a first advertising opportunity; and
receiving a selection of a first advertising opportunity to be removed from said first sponsorship package as part of said first proposal from said first advertiser.

18. The method of claim 17 further comprising:
receiving a first price bid for said first sponsorship package from said first advertiser.

19. The method of claim 18 further comprising:
transmitting said first price bid to said event coordinator.

20. The method of claim 19 further comprising:
receiving approval from said event coordinator for said first price bid; and
transmitting a contract to said first advertiser for said first sponsorship package.
